(19) United States
(12) Patent Application Publication
(10) Pub. No.: US 2007/0253406 A1
(43) Pub. Date: Nov. 1, 2007

(54) Methods, systems, and computer program products for provisioning subscriber line service on IP enabled network elements

(76) Inventors: Heyward E. Menasco JR., Hoover, AL (US); Joan L. Teer, Birmingham, AL (US); Alfonso Jones, Suwanee, GA (US)

Correspondence Address: MYERS BIGEL SIBLEY & SAJOVEC, P.A., P.O. BOX 37428, RALEIGH, NC, 27627, US

(21) Appl. No.: 11/413,319

(22) Filed: Apr. 28, 2006

(51) Int. Cl. H04L 12/66

(52) U.S. Cl. 370/352; 370/401

(57) ABSTRACT

A subscriber line is provisioned using a circuit identification such that services are associated with the subscriber line using the circuit identification and the services are disassociated with a telephone number assigned to the subscriber line.

### FIELD OF THE INVENTION

The present invention relates to communication networks and methods of operating the same, and, more particularly, to methods, system, and computer program products for provisioning subscriber lines (SLs) in communication networks.

### BACKGROUND OF THE INVENTION

Internet telephony, also referred to herein as Voice-Over Internet Protocol (VoIP), Voice-Over Network (VoN), and/or Internet Protocol Telephony (IP Telephony), is becoming increasingly popular due, in part, to marked improvements in reliability and sound quality of the service. The improved performance of Internet telephony communications may be due to upgrades made to the Internet backbone through improved switching fabrics, such as Asynchronous Transfer Mode (ATM) fabrics, and to implementation of new communications standards, such as standards for transport protocols, directory services, and/or audio codec format.

Currently, to provide Internet telephony communications to a customer, a customer obtains equipment, such as Integrated Access Devices (IADs), Analog Terminal Adaptors (ATAs), telephone adapters (TAs), and the like, to be installed at the customer's premises, for example, a customer's home. The equipment is used to support a voice path within the premises and through a broadband connection, for example, a digital subscriber line (DSL) connection, back to an Internet Service Provider (ISP). Once the necessary equipment is installed, customers/subscribers can connect their existing analog phones, for example, Plain Old Telephone Service (POTS) phones, to the ATA(s). The ATA(s) provide such functionality as dial tone, battery, and power ringing as part of providing POTS functionality through the VoN service. Normally, a Central Office (CO) switch provides dial tone, battery, and power ringing for analog phones.

Historically, Incumbent Local Exchange Carriers (ILECs) have viewed DSL service as an attribute of POTS service. Customers that subscribe to VoN service, however, may choose to eliminate their POTS service, which may result in managing DSL connections based on telephone numbers inconvenient and/or cumbersome. Moreover, pseudo telephone numbers may be created for the purpose of managing DSL connections, which may be wasteful as these telephone numbers are not used to provide actual communication service, but are used solely as an identifier for the DSL connections.

### SUMMARY OF THE INVENTION

According to some embodiments of the present invention, a subscriber line is provisioned using a circuit identification such that services are associated with the subscriber line using the circuit identification and the services are disassociated with a telephone number assigned to the subscriber line.

In other embodiments of the present invention, the SL is an analog subscriber line (ASL).

In still other embodiments of the present invention, the SL is a digital subscriber line (DSL).

In still other embodiments of the present invention, the method further comprises performing capacity activation for a DSLAM that is associated with the SL, comprising adding a DSL and/or IP-POTS port to a SWITCH database, and adding a line termination status for the DSL and/or IP-POTS port to an LFACS database.

In still other embodiments of the present invention, the method further comprises performing capacity activation for an Access Node that is associated with the SL, comprising adding a DSL and/or IP-POTS port to a SWITCH database, adding a DSL and/or IP-POTS circuit identification to the SWITCH database, and adding a line termination status for the DSL and/or IP-POTS port to an LFACS database.

In still other embodiments of the present invention, the method further comprises performing capacity activation for a DSLAM and/or an Access Node that is associated with the SL and is remote from a central office, comprising adding a DSL and/or IP-POTS port, a line termination status for the DSL and/or IP-POTS port, and a DSL and/or IP-POTS circuit identification to a LFACS database.

In still other embodiments of the present invention, the method further comprises performing service activation for the SL based on the circuit identification using a broadband network management system (BBNMS).

In still other embodiments of the present invention, the BBNMS further provisions service assurance tests for the SL based on the circuit identification.

In still other embodiments of the present invention, the method further comprises performing narrowband and/or broadband testing on the SL based on the circuit identification using the BBNMS.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIGS. 1A-1C are block diagrams that illustrate communication networks that provide digital subscriber line (DSL) service in accordance with some embodiments of the present invention;

FIG. 2 is a block diagram that illustrates provisioning a SL line based on a circuit identification in accordance with some embodiments of the present invention;

FIGS. 3A-3C illustrate communication networks that illustrate provisioning DSL and/or Internet Protocol-Plain Old Telephone Service (IP-POTS) on IP enabled network elements in accordance with some embodiments of the present invention; and

FIGS. 4-9 are flowcharts that illustrate operations for provisioning DSL and/or IP-POTS on IP enabled network elements in accordance with some embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For purposes of illustration, some embodiments of the present invention are described herein with respect to provisioning a digital subscriber line (DSL) using a circuit identification. It will be understood, however, that other types of subscriber lines (SLs), such as analog subscriber lines, Plain Old Telephone Service (POTS) lines, and/or IP-POTS lines may also be provisioned using a circuit identification.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

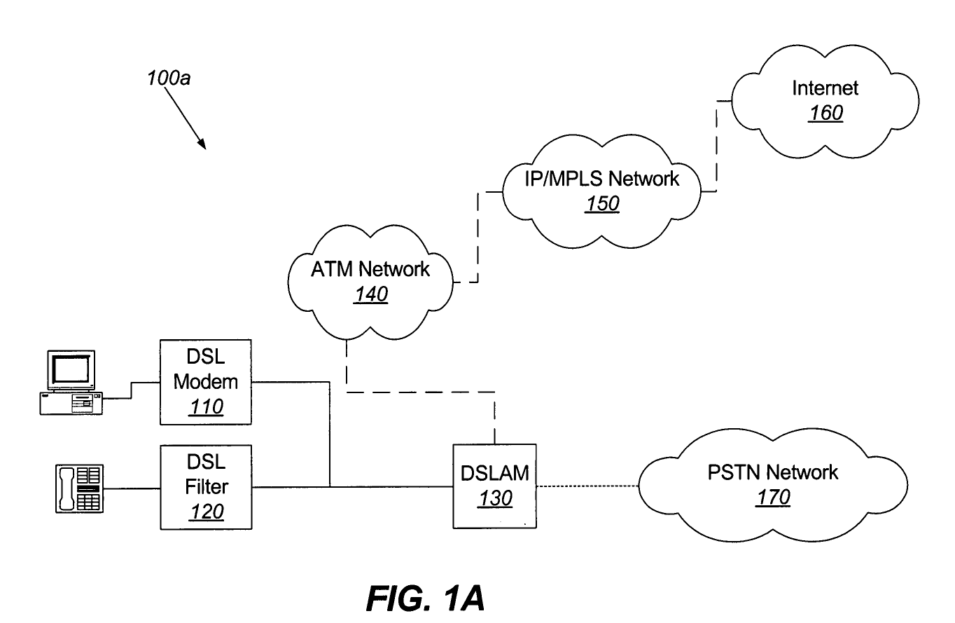

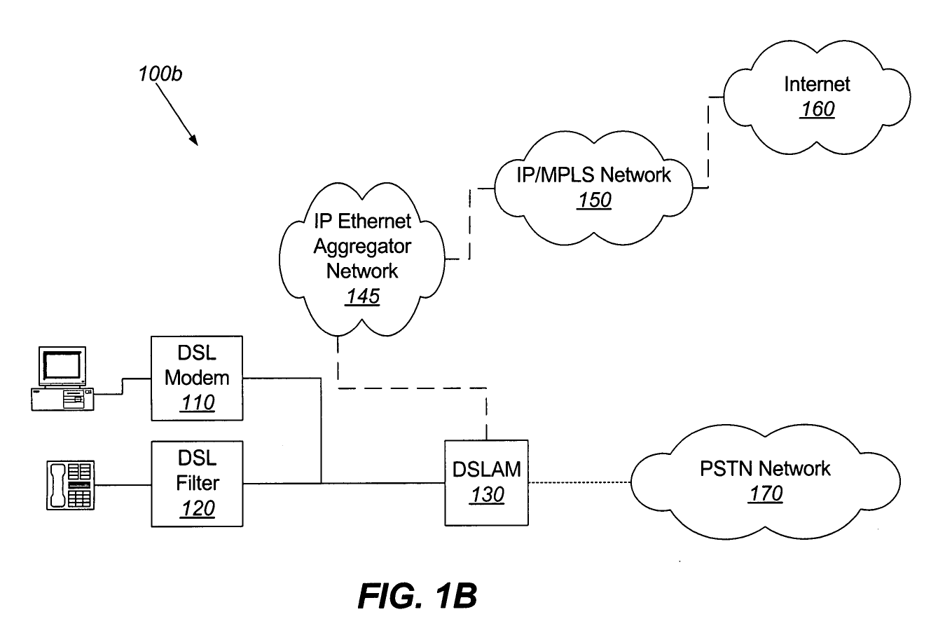

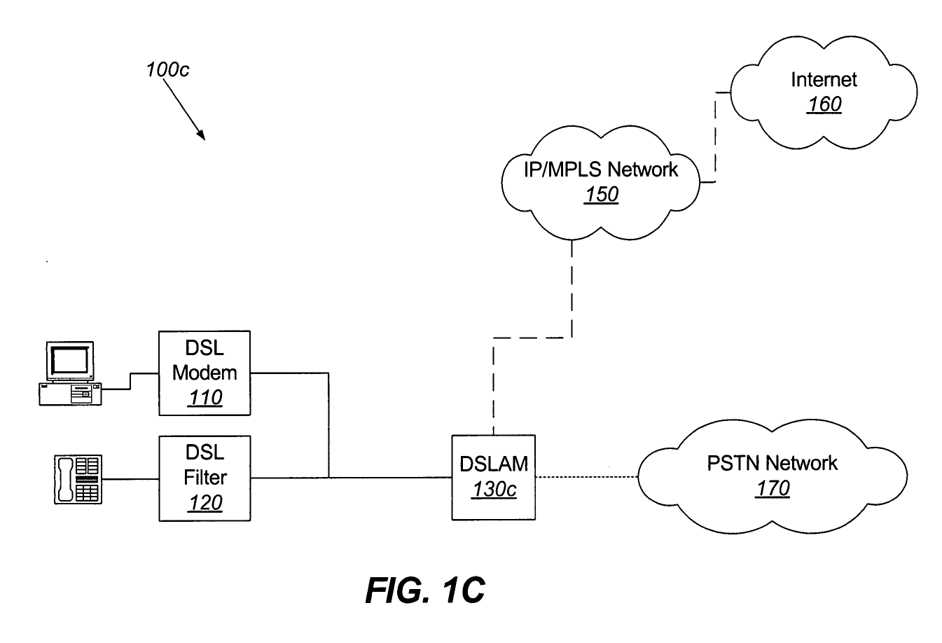

For example, as illustrated in FIG. 1A, a communication network 100a includes customer premises devices, such as a computer and analog phone, that are connected to a DSL via a DSL modem 110 and DSL filter 120, respectively. The DSL terminates at a Digital Subscriber Line Access Multiplexer (DSLAM) 130 where multiple DSL lines are typically multiplexed and the voice and data components are aggregated for transmission over the network. As shown in the FIG. 1, the data components are aggregated for transmission over an ATM network 140, an Internet Protocol/Multiprotocol Label Switching (IP/MPLS) network 150, and the Internet 160. The voice components are aggregated for transmission over the Public Switched Telephone Network (PSTN) 170.

Referring now to FIG. 1B, a communication network 100b is similar to that of FIG. 1A, but instead of an ATM network 140, an IP Ethernet aggregator network 145 is used to connect the DSLAM 130 to the IP/MPLS network 150. In still other embodiments shown in FIG. 1C, a communication network 100c may include an IP enabled DSLAM 130c that is connected directly to the IP/MPLS network 150.

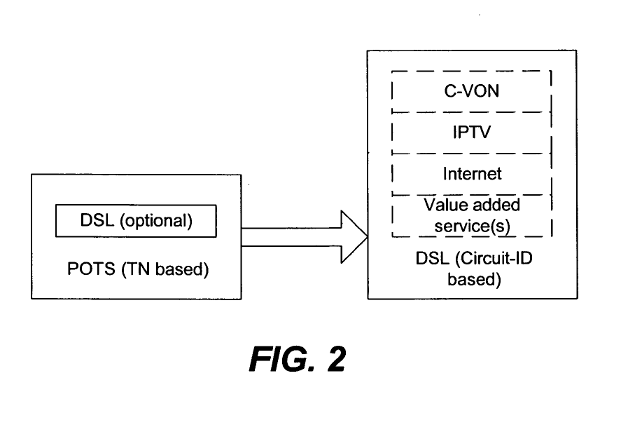

Referring now to FIG. 2, some embodiments of the present invention stem from a realization that a Digital Subscriber Line (DSL) may be converted from an attribute of Plain Old Telephone Service (POTS) to a circuit based identification. Thus, a DSL may be identified with a circuit identifier and various services, such as Consumer Voice over Network (C-VoN), Internet Protocol Television (IPTV), Internet Service, POTS, and other value added services may be associated with the circuit. Advantageously, this may allow Incumbent Local Exchange Carriers (ILECs), Competitive Local Exchange Carriers (CLECs) and/or other service providers to view telephone numbers as a logical and portable object that is not necessarily tied to a specific physical facility. For example, an ILEC may now provide true standalone DSL service, i.e., a DSL broadband connection without POTS service. In the past, even though a customer was not provided with POTS service, a pseudo telephone number was assigned to the DSL to manage the DSL service. By using a circuit identification to manage the DSL, a pseudo telephone number is no longer necessary. Moreover, management of the DSL is simplified as customers subscribe to particular C-VoN services, such as Internet Protocol VoN (IP-VoN) and/or Central Office VoN (CO-VoN) as these services may require porting a telephone number from an ILEC to a CLEC, which may require that the DSL be taken out of service if the DSL is managed based on telephone number. If the DSL is managed based on a circuit identification, however, than there may be no need to disrupt DSL service or the length of time that service is disrupted may be reduced.

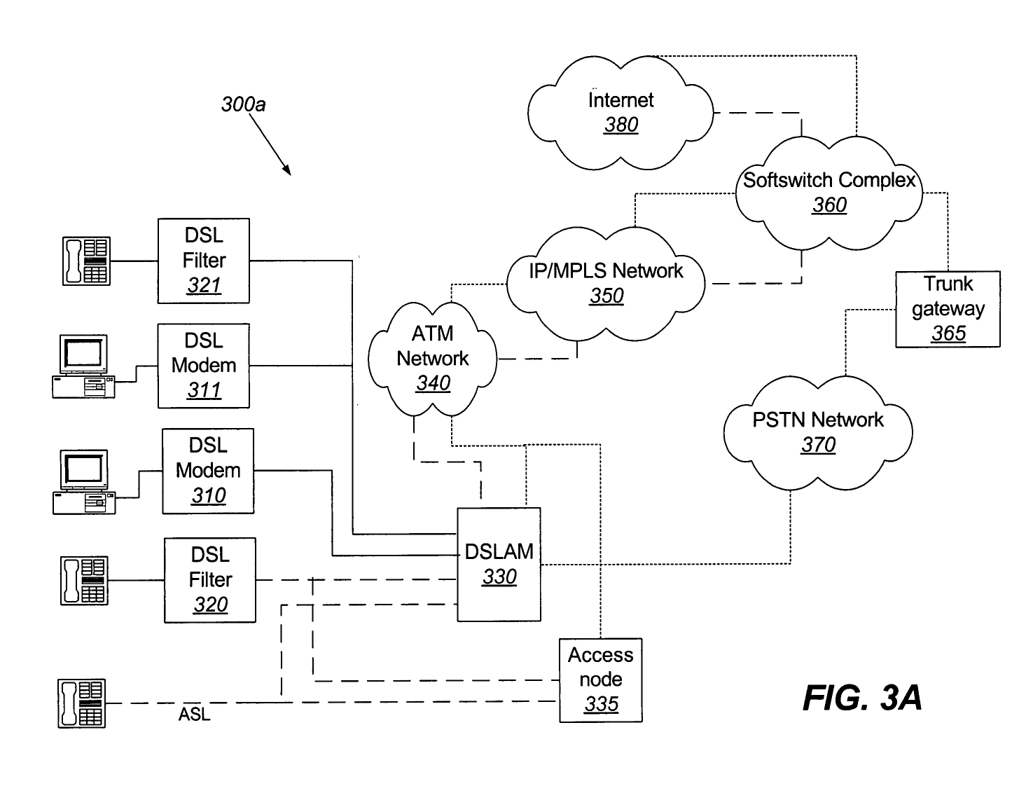

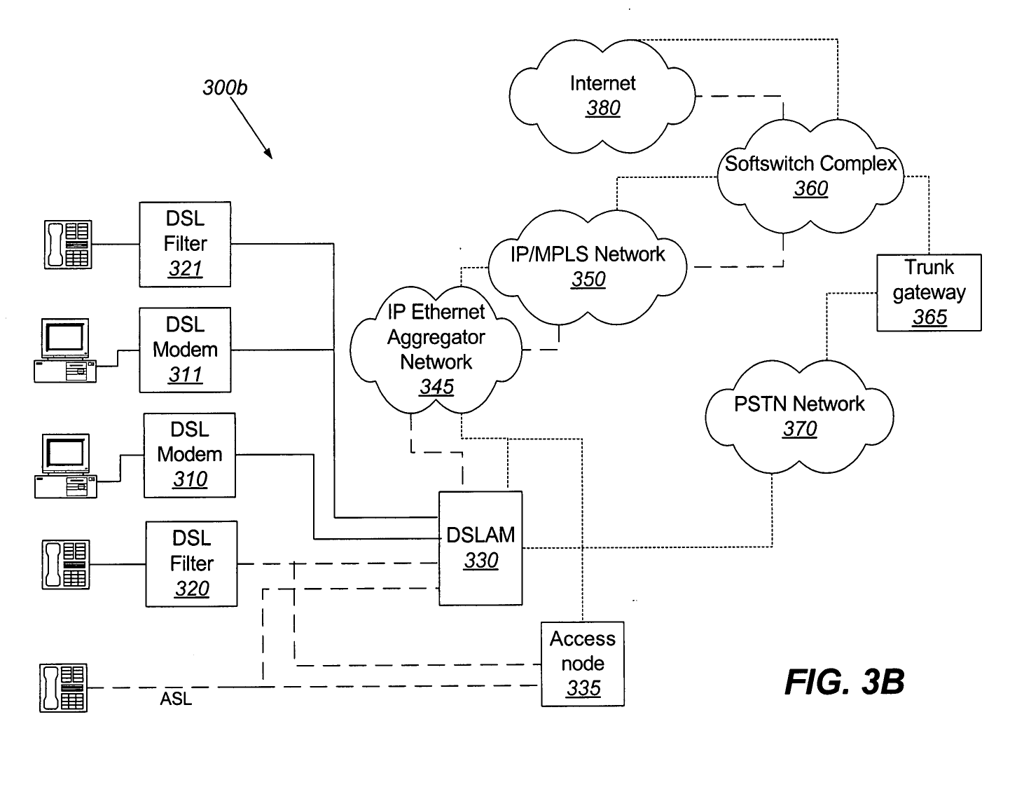

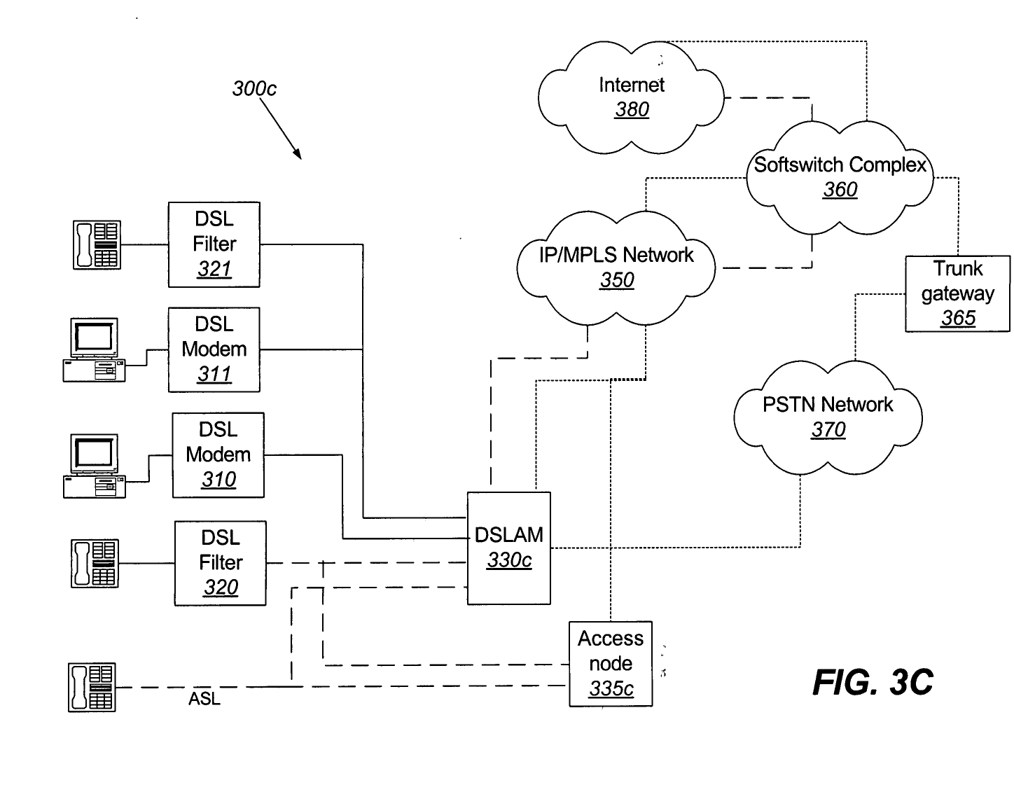

Referring now to FIG. 3A, an exemplary communication network 300a in which a DSL line may be provisioned based on a circuit identification, in accordance with some embodiments of the present invention, will now be described. The communication network 300a includes customer premises devices, such as a computer and analog phone, that are connected to a DSL via a DSL modem 310 and DSL filter 320, respectively. A modem 311 and DSL filter 321 may be used to provide voice service over a single DSL. The DSLs terminate at a Digital Subscriber Line Access Multiplexer (DSLAM) 330 where multiple DSL lines are typically multiplexed and the voice and data components are aggregated for transmission over the network. In some embodiments, the DSLAM 330 may be configured to terminate analog subscriber lines (ASLs), such as POTS lines. As shown in FIG. 3A, if a customer subscribes to IP-VoN service, then voice and data components are aggregated for transmission over an ATM network 340, an Internet Protocol/Multiprotocol Label Switching (IP/MPLS) network 350, and a softswitch complex 360. In some embodiments, IP-VoN implies that the customer purchase a customer access gateway device such that the telephone connects to the customer access gateway and the customer access gateway connects to the DSL modem 310. The customer may subscribe to POTS services, but still be aggregated for transmission via the Access Node 335. The Access Node 335 may provide POTS features and/or convert time division multiplexed traffic to packet or IP based traffic. In accordance with various embodiments of the present invention, an Access Node 335 may be used to terminate one or more DSLs and/or may provide gateway functionality between POTS and VoIP service. The network service provider, e.g., ILEC, CLEC, etc., may have the option of either connecting the customer directly to the PSTN 370 or connecting the customer to the Access Node 335. In some embodiments, the Access Node 335 may be part of the DSLAM 330, such as, for example, a DSLAM POTS/IP card. In general, the softswitch complex 360 may provide an interface between circuit switched networks and packet switched networks, such as between the PSTN network 370 and the Internet 380. The softswitch complex 360 may comprise elements, such as a softswitch, media server, and trunk gateway 365 that is used to establish connections to the PSTN network 370. Thus, as shown in FIG. 3A, voice traffic may be routed to the PSTN network 370 via a trunk gateway 365 while data traffic may be routed to the Internet 380. In some embodiments, voice traffic may also be routed via the Internet. Moreover, in further embodiments of the present invention, voice and data traffic may be separated such that data traffic is carried by the DSLAM 330 while an Access Node 335 is used to carry the voice traffic.

Referring now to FIG. 3B, a communication network 300b is similar to that of network 300a of FIG. 3A, but instead of an ATM network 340, an IP Ethernet aggregator network 345 is used to connect the DSLAM 330 and Access Node 335 to the IP/MPLS network 350. In still other embodiments shown in FIG. 3C, a communication network 100c may include an IP enabled DSLAM 330c and Access Node 335c that are connected directly to the IP/MPLS network 350.

Although FIGS. 3A-3C illustrate an exemplary communication networks, it will be understood that the present invention is not limited to such configurations, but is intended to encompass any configuration capable of carrying out the operations described herein.

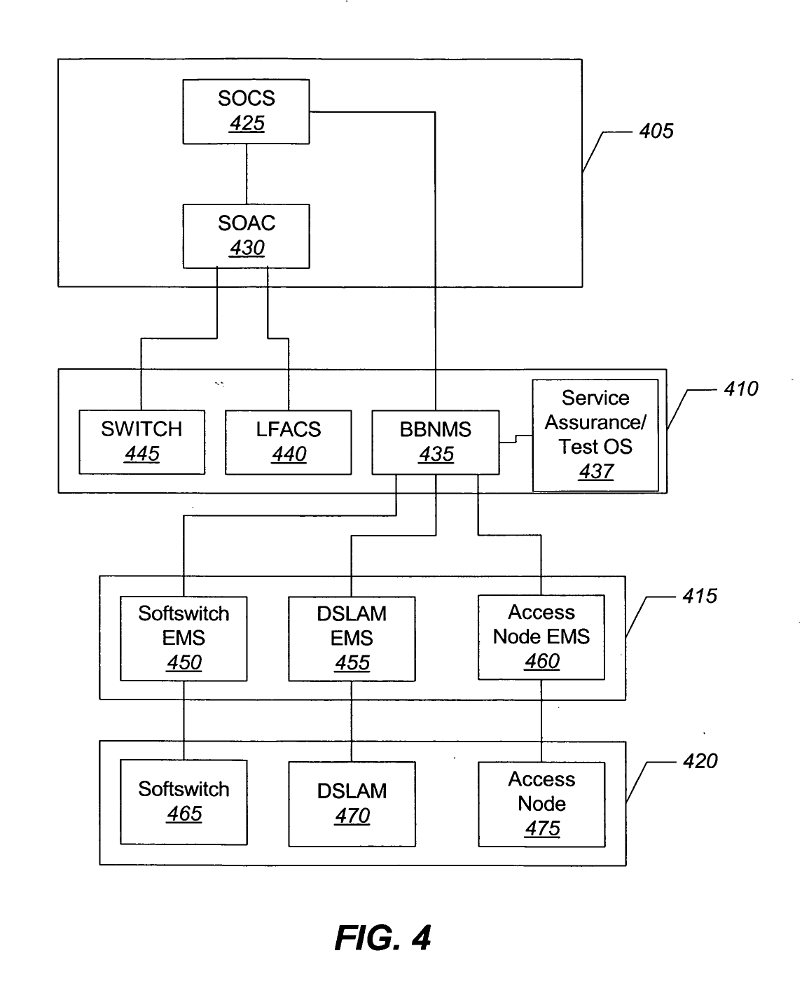

Referring to FIG. 4, a block diagram of a Network Operations Support System (OSS) model 400 that may be used to implement SL provisioning, in accordance with some embodiments of the present invention, is shown. The OSS model 400 comprises a business layer 405, a network management layer 410, an element management layer 415, and a network element layer 420. The business layer comprises a service order control system (SOCS) 425 and a service order analysis and control system (SOAC) 430. The SOCS 425 generates service orders based on information that is, for example, input to SOCS 425 through a user interface (e.g., typed by an operator receiving a customer service call), and/or based on information that is received from customers over a network, such as the Internet. The SOAC 430 is configured to control the flow of service orders, to coordinate and to track the progress of the service orders through the provisioning process. Based on user-modifiable tables and requested service activity, the SOAC 430 parses and interprets input orders from the SOCS 425 and determines the correct inventory and assignment components needed to establish or change a service.

The network management layer 410 comprises a Broadband Network Management System (BBNMS) 435 that provides a communication interface between the SOCS 425 and SOAC 430 and the various element management systems in the element management layer 415. The network management layer 410 further comprises a Loop Facilities Assignment and Control System (LFACS) 440, PLANET, or other type of loop inventory and assignment system that is configured to maintain up-to-date inventory records for all outside plant facilities, including physical cables and pairs (copper and fiber), digital loop carrier facilities, fiber-in-the-loop systems, terminals (distribution and cross-box), and customer service locations. In response to customer service requests, the LFACS 440 selects access facilities based on available equipment, and automatically reassigns facilities to accommodate maintenance and engineering activities. A SWITCH system 445 or other type of central office equipment assignment system may be used to maintain inventory and assignment records for various ports and circuits associated with network elements. A Service Assurance/Test Operation System (OS) 437 may process test requests, pull network assignment data from provisioning databases, test requests to element management layer systems, analyze test results, and/or manage trouble tickets.

The element management layer 415 comprises various element management systems that can be used by craft personnel to control one or more network elements. For example, the element management layer 415 comprises a softswitch element management system (EMS) 450 for managing a softswitch system, a DSLAM EMS 455 for managing one or more DSLAM systems, and an Access Node EMS 460 for managing one or more Access Nodes. The network element layer 420 comprises the network elements themselves, such as a softswitch system 465, one or more DSLAM systems 470, and one or more Access Nodes 475.

Computer program code for carrying out operations of the OSS model 400 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Exemplary operations for provisioning DSL and/or IP-POTS on IP enabled network elements will now be described. In particular, exemplary operations will be described for support of capacity activation, service activation, and fault management to support IP-POTS, DSLAM, and Access Node functionality. As used herein, capacity activation means the installation, growth, turn-up, and acceptance of new DSLAM and Access Node network elements in the central office and remote terminal locations. Service activation means the turn-up, provisioning, and disconnection of subscriber IP-POTS and data services on new DSLAM and Access Node network elements in the central office and remote terminal locations. Data services may include, but are not limited to, Internet Access, Internet Protocol Television (IPTV), multi-cast data, Internet gaming, music, and/or video conferencing. Fault management means service assurance functions, such as subscriber drop (cable pair) metallic loop tests, and other copper and high frequency testing. In addition to line testing, fault management functionality includes subscriber line records, softswitch data validation, DSLAM or Access Node data validation, network element alarms, alarm surveillance, alarm analysis, trouble isolation, maintenance dispatch, trouble resolutions, trouble ticket clearance, and/or subscriber service assurance.

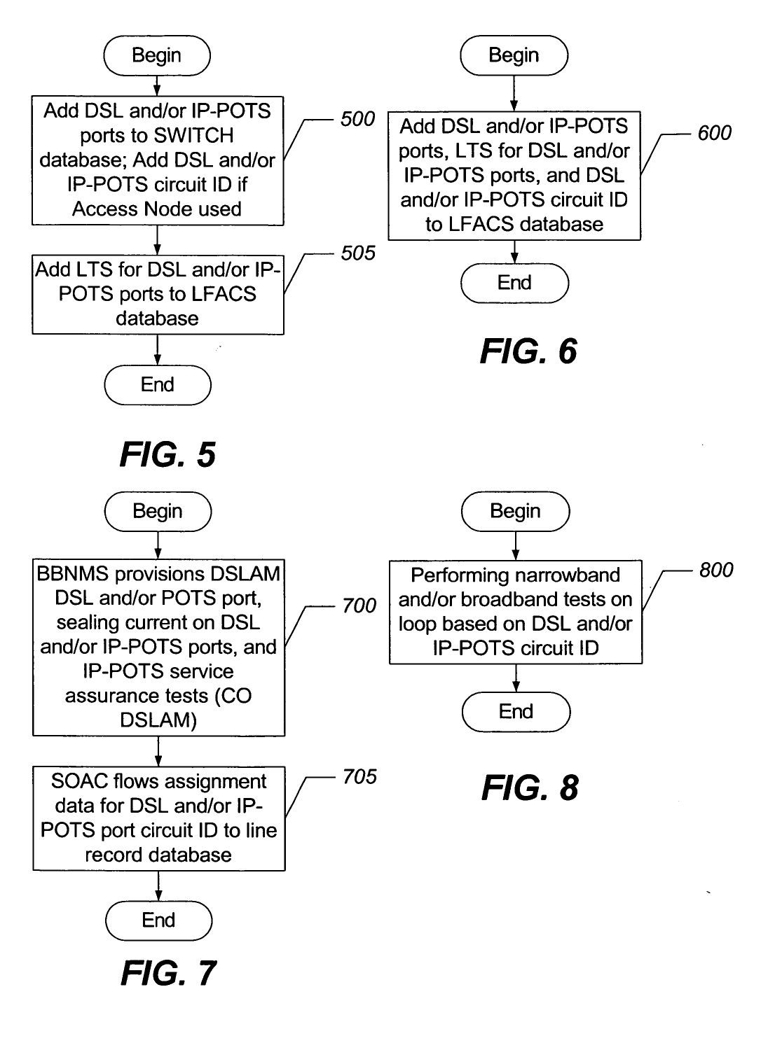

Referring to FIG. 5, operations for capacity activation in which the DSLAM or the DSLAM in combination with the Access Node are located at the central office begin at block 500 where the DSLAM DSL and/or IP-POTS ports are added to the SWITCH database 445. If the Access Node is used, then the DSLAM and Access Node ports are added to the SWITCH database 445. At block 505, the line termination status for the DSL and/or IP-POTS ports is added to the LFACS database 440.

Referring now to FIG. 6, if the DSLAM or the DSLAM in combination with the Access Node are located remote from the central office as remote terminals, then the DSL and/or IP-POTS ports, the line termination status for the DSL and/or IP-POTS ports, and the DSL and/or IP-POTS circuit identification are added to the LFACS database 440.

Service activation, in accordance with some embodiments of the present invention, will now be described with reference to FIG. 7. Operations begin at block 700 where the BBNMS 435 provisions the DSLAM DSL and/or POTS port and sealing current on DSL and/or POTS ports. If the DSLAM is located at the central office, then the BBNMS 435 executes POTS service assurance tests. At block 705, the SOAC 430 flows assignment data for the DSL and/or IP-POTS port circuit identification to a line record database.

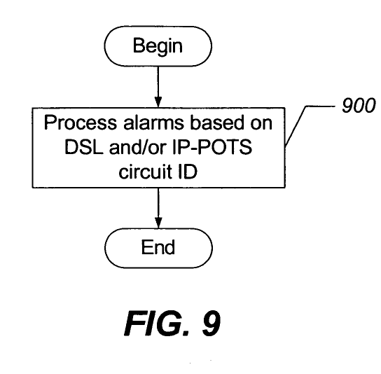

Referring now to FIGS. 8 and 9, the Service Assurance/Test Operation System (OS) 437 in cooperation with the BBNMS 435 may perform narrowband and/or broadband tests on the provisioned loops based on the DSL and/or IP-POTS circuit identification instead of being based on the directory number (DN) at block 800. At block 900, the BBNMS 435 may process alarms associated with network elements by looking up the network elements by circuit identification in one or more inventory databases.

According to some embodiments of the present invention, the BBNMS 435 may maintain information related to circuit identifications. Advantageously, by using circuit identification rather than directory number (DN) to inventory analog and digital subscriber lines, a customer's account can be managed independently of the customer's services or POTS telephone number. By decoupling the customer's account from the customer's telephone number, the customer's services can all be referenced by the same circuit identification for any combination of voice, data, IPTV, and/or other services. In addition, the circuit identification becomes the binding agent between systems in the OSS, including the network elements, the element management system (EMS) 415, the BBNMS 435, and all business layer 405 systems.

According to further embodiments of the present invention, as discussed above with respect to FIG. 7, the BBNMS 435 may provision service activation for all network elements, including the DSLAM, Access Nodes, softswitch, data services, voice services, etc. The BBNMS 435 in cooperation with the Service Assurance/Test Operation System (OS) 437 may supervise all narrowband and/or broadband tests on the provisioned loops based on the DSL and/or IP-POTS circuit identification.

Many variations and modifications can be made to the embodiments described herein without substantially departing from the principles of the present invention. All such variations and modifications are intended to be included herein within the scope of the present invention, as set forth in the following claims.

That which is claimed:

1. A method of provisioning a subscriber line (SL), comprising:
provisioning the SL using a circuit identification such that services are associated with the subscriber line using the circuit identification and the services are disassociated with a telephone number assigned to the subscriber line.

2. The method of claim 1, wherein the SL is an analog subscriber line (ASL).

3. The method of claim 1, wherein the SL is a digital subscriber line (DSL).

4. The method of claim 1, further comprising:
performing capacity activation for a DSLAM that is associated with the SL, comprising:
adding a DSL and/or IP-POTS port to a SWITCH database; and
adding a line termination status for the DSL and/or IP-POTS port to an LFACS database.

5. The method of claim 1, further comprising:
performing capacity activation for an Access Node that is associated with the SL, comprising:
adding a DSL and/or IP-POTS port to a SWITCH database;
adding a DSL and/or IP-POTS circuit identification to the SWITCH database; and
adding a line termination status for the DSL and/or IP-POTS port to an LFACS database.

6. The method of claim 1, further comprising:
performing capacity activation for a DSLAM and/or an Access Node that is associated with the SL and is remote from a central office, comprising:
adding a DSL and/or IP-POTS port, a line termination status for the DSL and/or IP-POTS port, and a DSL and/or IP-POTS circuit identification to a LFACS database.

7. The method of claim 1, further comprising:
performing service activation for the SL based on the circuit identification using a broadband network management system (BBNMS).

8. The method of claim 7, wherein the BBNMS is further configured to provision service assurance tests for the SL based on the circuit identification.

9. The method of claim 7, performing narrowband and/or broadband testing on the SL based on the circuit identification using the BBNMS.

10. A computer program product comprising a computer readable medium having computer readable program code embodied therein, the computer readable program code being configured to implement the method of claim 1.

11. An operations support system (OSS), comprising:
a network management system that is configured to provision a subscriber line (SL), using a circuit identification such that services are associated with the subscriber line using the circuit identification and the services are disassociated with a telephone number assigned to the subscriber line.

12. The OSS of claim 11, wherein the SL is an analog subscriber line (ASL).

13. The OSS of claim 11, wherein the SL is a digital subscriber line (DSL).

14. The OSS of claim 11, wherein the network management system is further configured to perform capacity activation for a DSLAM that is associated with the SL by adding a DSL and/or IP-POTS port to a SWITCH database, and adding a line termination status for the DSL and/or IP-POTS port to an LFACS database.

15. The OSS of claim 11, wherein the network management system is further configured to perform capacity activation for an Access Node that is associated with the SL by adding a DSL and/or IP-POTS port to a SWITCH database, adding a DSL and/or IP-POTS circuit identification to the SWITCH database, and adding a line termination status for the DSL and/or IP-POTS port to an LFACS database.

16. The OSS of claim 11, wherein the network management system is further configured to perform capacity activation for a DSLAM and/or an Access Node that is associated with the SL and is remote from a central office, by adding a DSL and/or IP-POTS port, a line termination status for the DSL and/or IP-POTS port, and a DSL and/or IP-POTS circuit identification to a LFACS database.

17. The OSS of claim 11, wherein the network management system is further configured to perform service activation for the SL based on the circuit identification using a broadband network management system (BBNMS).

18. The OSS of claim 17, wherein the BBNMS is further configured to provision service assurance tests for the SL based on the circuit identification.

19. The OSS of claim 17, wherein the network management system is further configured to perform narrowband and/or broadband testing on the SL based on the circuit identification using the BBNMS.
